(19) United States
(12) Patent Application Publication
(10) Pub. No.: US 2003/0104225 A1
(43) Pub. Date: Jun. 5, 2003

(54) Process for producing silica-based film, silica-based film, insulating film, and semiconductor device

(75) Inventors: Atsushi Shiota, Ibaraki (JP); Kouji Sumiya, Ibaraki (JP); Eiji Hayashi, Mie (JP); Kouichi Hasegawa, Ibaraki (JP); Youngsoo Seo, Chonan City (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: JSR CORPORATION, Tokyo (JP)

(21) Appl. No.: 10/270,066

(22) Filed: Oct. 15, 2002

Related U.S. Application Data
(63) Continuation-in-part of application No. 09/827,902, filed on Apr. 9, 2001, now Pat. No. 6,495,264.
(63) Continuation-in-part of application No. 09/770,289, filed on Jan. 29, 2001.

(30) Foreign Application Priority Data
Feb. 1, 2000 (JP) P. 2000-023559
Apr. 10, 2000 (JP) P. 2000-108311
Nov. 29, 2000 (JP) P. 2000-363513

(51) Int. Cl. B32B 9/04

(52) U.S. Cl. 428/447

(57) ABSTRACT

A process for producing a silica-based film which comprises irradiating a film comprising at least one siloxane compound having a radius of gyration of from 5 to 50 nm with electron beams to thereby convert the film into a film having a dielectric constant of 3 or lower is disclosed. The film has an even thickness, is excellent in storage stability, dielectric constant, mechanical strength, etc., has low hygroscopicity, and is suitable for use as a dielectric film in semiconductor devices and the like.

### CROSS-REFERENCE TO THE RELATED APPLICATIONS

This application is a continuation-in-part application of U.S. patent application Ser. No. 09/770,289 filed Jan. 29, 2001, entitled “PROCESS FOR PRODUCING SILICA-BASED FILM, SILICA-BASED FILM, INSULATING FILM, AND SEMICONDUCTOR DEVICE”, now pending, and U.S. patent application Ser. No. 09/827,902 filed Apr. 9, 2001, entitled “COMPOSITION FOR FILM FORMATION, METHOD OF FILM FORMATION, AND SILICA-BASED FILM”, now pending.

### FIELD OF THE INVENTION

The present invention relates to a process for producing a film. More particularly, the invention relates to a process capable of giving a coating film which is excellent in dielectric constant, mechanical strength, and low hygroscopicity, and is suitable for use as a dielectric film in semiconductor devices and the like.

### BACKGROUND OF THE INVENTION

Silica (SiO₂) films formed by vacuum processes such as the CVD method have hitherto been used frequently as dielectric films in semiconductor devices and other devices. In recent years, a dielectric film which comprises a tetraalkoxysilane hydrolyzate as the main component and is called an SOG (spin on glass) film has come to be used for the purpose of forming a more even dielectric film. Furthermore, as a result of the trend toward higher degree of integration in semiconductor devices and the like, a dielectric film called an organic SOG film has been developed which comprises a polyorganosiloxane as the main component and has a low dielectric constant.

However, with further progress in the high integration or multilayer film interconnection in semiconductor devices and the like, better electrical insulation between metal lines and vias has come to be required and, hence, a dielectric film has come to be desired which has satisfactory storage stability, a lower dielectric constant, and excellent leakage current characteristics.

JP-A-6-181201 (the term “JP-A” as used herein means an “unexamined published Japanese patent application”) discloses a dielectric film having a lower dielectric constant. This technique is intended to provide an insulating film for semiconductor devices which has low water absorption and excellent cracking resistance. This insulating film is formed from a composition which comprises as the main component an oligomer having a number average molecular weight of 500 or higher obtained by condensation-polymerizing an organometallic compound containing at least one element selected from titanium, zirconium, niobium, and tantalum with an organosilicon compound having at least one alkoxyl group in the molecule.

JP-A-10-237307 and WO 97/00535 disclose techniques for curing an SOG film with electron beams, which comprise irradiating a resin comprising a siloxane resin as the main component with electron beams. These techniques are intended to convert a siloxane resin into silica (SiO₂) by electron beam irradiation. The insulating film thus obtained usually has a dielectric constant of from 3.5 to 4.2, which is still too high to apply the insulating film to semiconductor devices which operate at a high frequency.

### SUMMARY OF THE INVENTION

Accordingly, one object of the invention is to provide a process for film production for eliminating the problem described above. More particularly, the object is to provide a process for producing an insulating film which has an excellent balance between dielectric constant and mechanical strength and is suitable for use as a dielectric film in semiconductor devices and the like.

Another object of the invention is to provide a process for producing a silica-based film which comprises irradiating a film comprising at least one siloxane compound with electron beams.

Still another object of the invention is to provide a film obtained by the process and an insulating film.

### DETAILED DESCRIPTION OF THE INVENTION

In the invention, a film comprising at least one siloxane compound (hereinafter referred to as “coating film”) is formed on a substrate.

For forming the coating film, a coating composition prepared by dissolving at least one siloxane compound in an organic solvent (hereinafter referred to as “coating composition”) is applied to a substrate and the organic solvent is removed from the coating.

Ingredient (A) which is the siloxane compound in the invention is a product of the hydrolysis and/or condensation of at least one compound selected from the group consisting of compounds represented by the following formula (1) (hereinafter referred to as “compounds (1)”):

R¹ₐSi(OR²)₄₋ₐ (1)

wherein R¹ represents a hydrogen atom or a monovalent organic group; R² represents.a monovalent organic group; and a Is an integer of 0 to 2,

and compounds represented by the following formula (2) (hereinafter referred to as “compounds (2)”):

R³_{b}(R⁴O)_{3-b}Si—(R⁷)_{d}—Si(OR⁵)_{3-c}R⁶_{c} (2)

wherein R³, R⁴, R⁵, and R⁶ may be the same or different and each represents a monovalent organic group; b and c may be the same or different and each is an integer of 0 to 2; R⁷ represents an oxygen atom or a group represented by —(CH₂)ₙ—, wherein n is 1 to 6; and d is 0 or 1.

Examples of the monovalent organic groups represented by R¹ and R² in formula (1) include alkyl, aryl, allyl, and glycidyl groups. In formula (1), R¹ is preferably a monovalent organic group, more preferably an alkyl or phenyl group.

The alkyl group preferably has 1 to 5 carbon atoms, and examples thereof include methyl, ethyl, propyl, and butyl. Those alkyl groups may be linear or branched, and may be ones in which one or more of the hydrogen atoms have been replaced, for example, with fluorine atoms.

In formula (1), examples of the aryl group include phenyl, naphthyl, methylphenyl, ethylphenyl, chlorophenyl, bromophenyl, and fluorophenyl.

Specific examples of the compounds represented by formula (1) include: trialkoxysilanes such as trimethoxysilane, triethoxysilane, tri-n-propoxysilane, triisopropoxysilane, tri-n-butoxysilane, tri-sec-butoxysilane, tri-tert-butoxysilane, triphenoxysilane, fluorotrimethoxysilane, fluorotriethoxysilane, fluorotri-n-propoxysilane, fluorotriisopropoxysilane, fluorotri-n-butoxysilane, fluorotri-sec-butoxysilane, fluorotri-tert-butoxysilane, and fluorotriphenoxysilane; tetraalkoxysilanes such as tetramethoxysilane, tetraethoxysilane, tetra-n-propoxysilane, tetraisopropoxysilane tetra-n-butoxysilane, tetra-sec-butoxysilane, tetra-tert-butoxysilane, and tetraphenoxysilane; alkyltrialkoxysilanes such as methyltrimethoxysilane, methyltriethoxysilane, methyltri-n-propoxysilane, methyltriisopropoxysilane, methyltri-n-butoxysilane, methyltri-sec-butoxysilane, methyltri-tert-butoxysilane, methyltriphenoxysilane, ethyltrimethoxysilane, ethyltriethoxysilane, ethyltri-n-propoxysilane, ethyltriisopropoxysilane, ethyltri-n-butoxysilane, ethyltri-sec-butoxysilane, ethyltri-tert-butoxysilane, ethyltriphenoxysilane, vinyltrimethoxysilane, vinyltriethoxysilane, vinyltri-n-propoxysilane, vinyltriisopropoxysilane, vinyltri-n-butoxysilane, vinyltri-sec-butoxysilane, vinyltri-tert-butoxysilane, vinyltriphenoxysilane, n-propyltrimethoxysilane, n-propyltriethoxysilane, n-propyltri-n-propoxysilane, n-propyltriisopropoxysilane, n-propyltri-n-butoxysilane, n-propyltri-sec-butoxysilane, n-propyltri-tert-butoxysilane, n-propyltriphenoxysilane, isopropyltrimethoxysilane, isopropyltriethoxysilane, isopropyltri-n-propoxysilane, isopropyltriisopropoxysilane, isopropyltri-n-butoxysilane, isopropyltri-sec-butoxysilane, isopropyltri-tert-butoxysilane, isopropyltriphenoxysilane, n-butyltrimethoxysilane, n-butyltriethoxysilane, n-butyltri-n-propoxysilane, n-butyltriisopropoxysilane, n-butyltri-n-butoxysilane, n-butyltri-sec-butoxysilane, n-butyltri-tert-butoxysilane, n-butyltriphenoxysilane, sec-butyltrimethoxysilane, sec-butyltriethoxysilane, sec-butyltri-n-propoxysilane, sec-butyltriisopropoxysilane, sec-butyltri-n-butoxysilane, sec-butyltri-sec-butoxysilane, sec-butyltri-tert-butoxysilane, sec-butyltriphenoxysilane, tert-butyltrimethoxysilane, tert-butyltriethoxysilane, tert-butyltri-n-propoxysilane, tert-butyltriisopropoxysilane, tert-butyltri-n-butoxysilane, tert-butyltri-sec-butoxysilane, and tert-butyltri-tert-butoxysilane; tert-butyltriphenoxysilane, phenyltrimethoxysilane, phenyltriethoxysilane, phenyltri-n-propoxysilane, phenyltriisopropoxysilane, phenyltri-n-butoxysilane, phenyltri-sec-butoxysilane, phenyltri-tert-butoxysilane, phenyltriphenoxysilane, vinyltrimethoxysilane, vinyltriethoxysilane, γ-aminopropyltrimethoxysilane, γ-aminopropyltriethoxysilane, γ-glycidoxypropyltrimethoxysilane, γ-glycidoxypropyltriethoxysilane, γ-trifluoropropyltrimethoxysilane, and γ-trifluoropropylt riethoxysilane; and dimethyldimethoxysilane, dimethyldiethoxysilane, dimethyldi-n-propoxysilane, dimethyldiisopropoxysilane, dimethyldi-n-butoxysilane, dimethyldi-sec-butoxysilane, dimethyldi-tert-butoxysilane, dimethyldiphenoxysilane, diethyldimethoxysilane, diethyldiethoxysilane, diethyldi-n-propoxysilane, diethyldiisopropoxysilane, diethyldi-n-butoxysilane, diethyldi-sec-butoxysilane, diethyldi-tert-butoxysilane, diethyldiphenoxysilane, di-n-propyldimethoxysilane, di-n-propyldiethoxysilane, di-n-propyldi-n-propoxysilane, di-n-propyldiisopropoxysilane, di-n-propyldi-n-butoxysilane, di-n-propyldi-sec-butoxysilane, di-n-propyldi-tert-butoxysilane, di-n-propyldiphenoxysilane, diisopropyldimethoxysilane, diisopropyldiethoxysilane, diisopropyldi-n-propoxysilane, diisopropyldiisopropoxysilane, diisopropyldi-n-butoxysilane, diisopropyldi-sec-butoxysilane, diisopropyldi-tert-butoxysilane, diisopropyldiphenoxysilane, di-n-butyldimethoxysilane, di-n-butyldiethoxysilane, di-n-butyldi-n-propoxysilane, di-n-butyldiisopropoxysilane, di-n-butyldi-n-butoxysilane, di-n-butyldi-sec-butoxysilane, di-n-butyldi-tert-butoxysilane, di-n-butyldiphenoxysilane, di-sec-butyldimethoxysilane, di-sec-butyldiethoxysilane, di-sec-butyldi-n-propoxysilane, di-sec-butyldiisopropoxysilane, di-sec-butyldi-n-butoxysilane, di-sec-butyldi-sec-butoxysilane, di-sec-butyldi-tert-butoxysilane, di-sec-butyldiphenoxysilane, di-tert-butyldimethoxysilane, di-tert-butyldiethoxysilane, di-tert-butyldi-n-propoxysilane, di-tert-butyldiisopropoxysilane, di-tert-butyldi-n-butoxysilane, di-tert-butyldi-sec-butoxysilane, di-tert-butyldi-tert-butoxysilane, di-tert-butyldiphenoxysilane, diphenyldimethoxysilane, diphenyldiethoxysilane, diphenyldi-n-propoxysilane, diphenyldiisopropoxysilane, diphenyldi-n-butoxysilane, diphenyldi-sec-butoxysilane, diphenyldi-tert-butoxysilane, diphenyldiphenoxysilane, divinyltrimethoxysilane, γ-aminopropyltrimethoxysilane, γ-aminopropyltriethoxysilane, γ-glycidoxypropyltrimethoxysilane, γ-glycidoxypropyltriethoxysilane, γ-trifluoropropyltrimethoxysilane, and γ-trifluoropropyltriethoxysilane.

Preferable compounds (1) are tetramethoxysilane, tetraethoxysilane, tetra-n-propoxysilane, tetraisopropoxysilane, tetraphenoxysilane, methyltrimethoxysilane, methyltriethoxysilane, methyltri-n-propoxysilane, methyltriisopropoxysilane, ethyltrimethoxysilane, ethyltriethoxysilane, vinyltrimethoxysilane, vinyltriethoxysilane, phenyltrimethoxysilane, phenyltriethoxysilane, dimethyldimethoxysilane, dimethyldiethoxysilane, diethyldimethoxysilane, diethyldiethoxysilane, diphenyldimethoxysilane, diphenyldiethoxysilane, trimethylmonomethoxysilane, trimethylmonoethoxysilane, triethylmonomethoxysilane, triethylmonoethoxysilane, triphenylmonomethoxysilane, and triphenylmonoethoxysilane.

In formula (2), examples of the monovalent organic group include the same organic groups as those enumerated above with regard to formula (1).

Examples of the divalent organic group represented by R⁷ in formula (2) include alkylene groups having 2 to 6 carbon atoms, such as methylene.

Examples of the compounds represented by formula (2) wherein R⁷ is an oxygen atom include hexamethoxydisiloxane, hexaethoxydisiloxane, hexaphenoxydisiloxane, 1,1,1,3,3-pentamethoxy-3-methyldisiloxane, 1,1,1,3,3-pentaethoxy-3-methyldisiloxane, 1,1,1,3,3-pentamethoxy-3-phenyldisiloxane, 1,1,1,3,3-pentaethoxy-3-phenyldisiloxane, 1,1,3,3-tetramethoxy-1,3-dimethyldisiloxane, 1,1,3,3-tetraethoxy-1,3-dimethyldisiloxane, 1,1,3,3-tetramethoxy-1,3-diphenyldisiloxane, 1,1,3,3-tetraethoxy-1,3-diphenyldisiloxane, 1,1,3-trimethoxy-1,3,3-trimethyldisiloxane, 1,1,3-triethoxy-1,3,3,3,3-trimethyldisiloxane, 1,1,3-trimethoxy-1,1,3,3triphenyldisiloxane, 1,1,3-triethoxy-1,3,3-triphenyldisiloxane, 1,3-dimethoxy-1,1,3,3-tetramethyldisiloxane, 1,3-diethoxy-1,1,3,3-tetramethyldisiloxane, 1,3-dimethoxy-1,1,3,3-tetraphenyldisiloxane, and 1,3-diethoxy-1,1,3,3-tetraphenyldisiloxane. Of those, preferable compounds are hexamethoxydisiloxane, hexaethoxydisiloxane, 1,1,3,3-tetramethoxy-1,3-dimethyldisiloxane, 1,1,3,3-tetraethoxy-1,3-dimethyldisiloxane, 1,1,3,3-tetramethoxy-1,3-diphenyldisiloxane, 1,3-dimethoxy-1,1,3,3-tetramethyldisiloxane, 1,3-diethoxy-1,1,3,3-tetramethyldisiloxane, 1,3-dimethoxy-1,1,3,3-tetraphenyldisiloxane, 1,3-diethoxy-1,1,3,3-tetraphenyldisiloxane, and the like.

Examples of the compounds represented by formula (2) wherein d is 0 include hexamethoxydisilane, hexaethoxydisilane, hexaphenoxydisilane, 1,1,1,2,2-pentamethoxy-2-methyldisilane, 1,1,1,2,2-pentaethoxy-2-methyldisilane, 1,1,1,2,2-pentamethoxy-2-phenyldisilane, 1,1,1,2,2-pentaethoxy-2-phenyldisilane, 1,1,2,2-tetramethoxy-1,2-dimethyldisilane, 1,1,2,2-tetraethoxy-1,2-dimethyldisilane, 1,1,2,2-tetramethoxy-1,2-diphenyldisilane, 1,1,2,2-tetraethoxy-1,2-diphenyldisilane, 1,1,2-trimethoxy-1,2,2-trimethyldisilane, 1,1,2-triethoxy-1,2,2-trimethyldisilane, 1,1,2-trimethoxy-1,2,2-triphenyldisilane, 1,1,2-triethoxy-1,2,2-triphenyldisilane, 1,2-dimethoxy-1,1,2,2-tetramethyldisilane, 1,2-diethoxy-1,1,2,2-tetramethyldisilane, 1,2-dimethoxy-1,1,2,2-tetraphenyldisilane, and 1,2-diethoxy-1,1,2,2-tetraphenyldisilane.

Examples of the compounds represented by formula (2) wherein R⁷ is a group represented by —(CH₂)ₙ— include bis(hexamethoxysilyl)methane, bis(hexaethoxysilyl)methane, bis(hexaphenoxysilyl)methane, bis(dimethoxymethylsilyl)methane, bis(diethoxymethylsilyl)methane, bis(dimethoxyphenylsilyl)methane, bis(diethoxyphenylsilyl)methane, bis(methoxydimethylsilyl)methane, bis(ethoxydimethylsilyl)methane, bis(methoxydiphenylsilyl)methane, bis(ethoxydiphenylsilyl)methane, bis(hexamethoxysilyl)ethane, bis(hexaethoxysilyl)ethane, bis(hexaphenoxysilyl)ethane, bis(dimethoxymethylsilyl)ethane, bis(diethoxymethylsilyl)ethane, bis(dimethoxyphenylsilyl)ethane, bis(diethoxyphenylsilyl)ethane, bis(methoxydimethylsilyl)ethane, bis(ethoxydimethylsilyl)ethane, bis(methoxydiphenylsilyl)ethane, bis(ethoxydiphenylsilyl)ethane, 1,3-bis(hexamethoxysilyl)propane, 1,3-bis(hexaethoxysilyl)propane, 1,3-bis(hexaphenoxysilyl)propane, 1,3-bis(dimethoxymethylsilyl)propane, 1,3-bis(diethoxymethylsilyl)propane, 1,3-bis(dimethoxyphenylsilyl)propane, 1,3-bis(diethoxyphenylsilyl)propane, 1,3-bis(methoxydimehylsilyl)propane, 1,3-bis(ethoxydimethylsilyl)propane, 1,3-bis(methoxydiphenylsilyl)propane, and 1,3-bis(ethoxydiphenylsilyl)propane. Of those, preferable compounds are hexamethoxydisilane, hexaethoxydisilane, hexaphenoxydisilane, 1,1,2,2-tetramethoxy-1,2-dimethyldisilane, 1,1,2,2-tetraethoxy-1,2-dimethyldisilane, 1,1,2,2-tetramethoxy-1,2-diphenyldisilane, 1,1,2,2-tetraethoxy-1,2-diphenyldisilane, 1,2-dimethoxy-1,1,2,2-tetramethyldisilane, 1,2-diethoxy-1,1,2,2-tetramethyldisilane, 1,2-dimethoxy-1,1,2,2-tetraphenyldisilane, 1,2-diethoxy-1,1,2,2-tetraphenyldisilane, bis(hexamethoxysilyl)methane, bis(hexaethoxysilyl)methane, bis(dimethoxymethylsilyl)methane, bis(diethoxymethylsilyl)methane, bis(dimethoxyphenylsilyl)methane, bis(diethoxyphenylsilyl)methane, bis(methoxydimethylsilyl)methane, bis(ethoxydimethylsilyl)methane, bis(methoxydiphenylsilyl)methane, and bis(ethoxydiphenylsilyl)methane.

In the invention, it is preferred to use a combination of an alkyltrialkoxysilane and a tetraalkoxysilane among the compounds (1) and (2) enumerated above. In this case, the proportion of the tetraalkoxysilane is generally from 5 to 75% by weight, preferably from 10 to 70% by weight, more preferably from 15 to 70% by weight, and that of the alkyltrialkoxysilane is generally from 25 to 95% by weight, preferably from 30 to 90% by weight, more preferably from 30 to 85% by weight, in terms of the amount of the product of complete hydrolysis and condensation. When a tetraalkoxysilane and a trialkoxysilane are used in a proportion within that range, the coating film obtained has a high modulus of elasticity and an exceedingly low dielectric constant.

The term “product of complete hydrolysis and condensation” as used herein means a product in which all the R²O—, R⁴O—, and R⁵O— groups in the compounds (1) and (2) have been hydrolyzed into SiOH groups and completely condensed to form a siloxane structure.

When at least one silane compound selected from the group consisting of the compounds (1) and (2) is hydrolyzed and condensed, water is used in an amount of preferably from more than 20 mol to 150 mol, more preferably from more than 20 mol to 130 mol, per mol of the at least one compound selected from the compounds (1) and (2). If water is added in an amount of 20 mol or smaller, there are cases where the resultant composition gives a coating film having poor cracking resistance. On the other hand, if the amount of water added is larger than 150 mol, there are cases where polymer precipitation or gelation occurs during the hydrolysis and condensation reactions.

The addition of at least one silane compound selected from the group consisting of the compounds (1) and (2) to the reaction mixture may be conducted en bloc, or may be conducted continuously or intermittently. In the case where at least one silane compound selected from the group consisting of the compounds (1) and (2) is added continuously or intermittently, the period of addition is preferably from 5 minutes to 12 hours.

The production of the product of hydrolysis and condensation (A) for use in the invention is characterized in that a specific basic compound is used in hydrolyzing and condensing at least one silane compound selected from the group consisting of the compounds (1) and (2).

By using a specific basic compound, a silica-based film having a low dielectric constant, a high modulus of elasticity, and excellent adhesion to substrates can be obtained.

Examples of specific basic compounds which can be used in the invention include tetraalkylammonium hydroxides such as tetramethylammonium hydroxide, tetraethylammonium hydroxide, tetrapropylammonium hydroxide, and tetrabutylammonium hydroxide, alicyclic organic amines such as piperidine, 1-methylpiperidine, 2-methylpiperidine, 3-methylpiperidine, 4-methylpiperidine, piperazine, 1-methylpiperazine, 2-methylpiperazine, 1,4-dimethylpiperazine, pyrrolidine, 1-methylpyrrolidine, diazabicyclooctane, diazabicyclononane, diazabicycloundecene, 2-pyrazoline, 3-pyrroline, and quinuclidine, and metal hydroxides such as sodium hydroxide, potassium hydroxide, lithium hydroxide, and cesium hydroxide. Especially preferred of these from the standpoint of the adhesion of a silica-based film to substrates are tetramethylammonium hydroxide, tetraethylammonium hydroxide, tetrapropylammonium hydroxide, tetrabutylammonium hydroxide, piperidine, 1-methylpiperidine, piperazine, 1-methylpiperazine, 1,4-dimehylpiperazine, pyrrolidine, 1-methylpyrrolidine, diazabicyclooctane, diazabicyclononane, diazabicycloundecene, sodium hydroxide, potassium hydroxide, and lithium hydroxide.

Those specific basic compounds may be used alone or in combination of two or more thereof.

The specific basic compound is used in an amount of generally from 0.00001 to 10 mol, preferably from 0.00005 to 5 mol, more preferably from 0.001 to 1 mol, most preferably from 0.01 to 0.5 mol per mol of the total amount of the R¹O—, R²O—, R⁴O—, and R⁵O— groups contained in the compounds (1) to (3). As long as-the specific basic compound is used in an amount within that range, polymer precipitation or gelatin is less apt to occur during the reaction.

The radius of gyration of the product of hydrolysis and condensation (A) thus obtained is preferably from 5 to 50 nm, more preferably from 8 to 40 nm, most preferably from 9 to 30 nm, in terms of radius of gyration determined by the GPC (refractive index, viscosity, or light scattering) method. When the product of hydrolysis and condensation has a radius of gyration of from 5 to 50 nm, the composition can give a silica-based film excellent especially in dielectric constant, modulus of elasticity, and evenness of the film.

The product of hydrolysis and condensation (A) thus obtained is characterized by being not particulate and hence having excellent applicability to substrates. That the product of hydrolysis and condensation (A) is not particulate can be ascertained through examination with, e.g., a transmission electron microscope (TEM).

In producing a product of hydrolysis and condensation (A), at least one silane compound selected from the group consisting of compounds (1) to (3) is hydrolyzed and condensed in the presence of a specific basic compound so that the resultant product of hydrolysis and condensation preferably has a radius of gyration of from 5 to 50 nm. It is preferred to adjust the pH of the resultant composition to 7 or lower.

Examples of techniques for pH adjustment include:

(1) to add a pH regulator;

(2) to distill off the specific basic compound from the composition at ordinary or reduced pressure;

(3) to bubble a gas such as nitrogen or argon into the composition to thereby remove the specific basic compound from the composition;

(4) to remove the specific basic compound from the composition with an ion-exchange resin; and

(5) to remove the specific basic compound from the system by extraction or washing.

Those techniques may be used alone or in combination of two or more thereof.

Examples of the pH regulator include inorganic acids and organic acids.

Examples of the inorganic acids include hydrochloric acid, nitric acid, sulfuric acid, hydrofluoric acid, phosphoric acid, boric acid, and oxalic acid.

Examples of the organic acids include acetic acid, propionic acid, butanoic acid, pentanoic acid, hexanoic acid, heptanoic acid, octanoic acid, nonanoic acid, decanoic acid, oxalic acid, maleic acid, methylmalonic acid, adipic acid, sebacic acid, gallic acid, butyric acid, mellitic acid, arachidonic acid, shikimic acid, 2-ethylhexanoic acid, oleic acid, stearic acid, linoleic acid, linolenic acid, salicylic acid, benzoic acid, p-aminobenzoic acid, p-toluenesulfonic acid, benzenesulfonic acid, monochloro acetic acid, dichloroacetic acid, trichloroacetic acid, trifluoroacetic acid, formic acid, malonic acid, sulfonic acids, phthalic acid, fumaric acid, citric acid, tartaric acid, succinic acid, itaconic acid, mesaconic acid, citraconic acid, malic acid, a glutaric acid hydrolyzate, a maleic anhydride hydrolyzate, and a phthalic anhydride hydrolyzate.

Those compounds may be used alone or in combination of two or more thereof.

Such a pH regulator is used to adjust the pH of the composition to 7 or lower, preferably 1 to 6. The method described above which comprises regulating the radius of gyration of the product of hydrolysis and condensation to from 5 to 50 nm and then adjusting the pH thereof with the pH regulator to a value within that range produces the effect that the composition obtained has improved storage stability.

The pH regulator is used in an amount suitably selected so that the pH of the composition becomes a value within that range.

In the invention, the siloxane compound is usually dissolved in an organic solvent and applied as a coating composition.

Examples of the solvent which can be used in the invention include aliphatic hydrocarbon solvents such as n-pentane, isopentane, n-hexane, isohexane, n-heptane, isoheptane, 2,2,4-trimethylpentane, n-octane, isooctane, cyclohexane, and methylcyclohexane; aromatic hydrocarbon solvents such as benzene, toluene, xylene, ethylbenzene, trimethylbenzene, methylethylbenzene, n-propylbenzene, isopropylbenzene, diethylbenzene, isobutylbenzene, triethylbenzene, diisopropylbenzene, n-amylnaphthalene, and trimethylbenzene; monohydric alcohols such as methanol, ethanol, n-propanol, isopropanol, n-butanol, isobutanol, sec-butanol, t-butanol, n-pentanol, isopentanol, 2-methylbutanol, sec-pentanol, t-pentanol, 3-methoxybutanol, n-hexanol, 2-methylpentanol, sec-hexanol, 2-ethylbutanol, sec-heptanol, heptanol-3, n-octanol, 2-ethylhexanol, sec-octanol, n-nonyl alcohol, 2,6-dimethylheptanol-4, n-decanol, sec-undecyl alcohol, trimethylnonyl alcohol, sec-tetradecyl alcohol, sec-heptadecyl alcohol, phenol, cyclohexanol, methylcyclohexanol, 3,3,5-trimethylcyclohexanol, benzyl alcohol, phenylmethylcarbinol diacetone alcohol, and cresol; polyhydric alcohols such as ethylene glycol, 1,2-propylene glycol, 1,3-butylene glycol, pentanediol-2,4, 2-methylpentanediol-2,4, hexanediol-2,5, heptanediol-2,4,2-ethylhexanediol-1,3, diethylene glycol, dipropylene glycol, triethylene glycol, tripropylene glycol, and glycerol; ketone solvents such as acetone, methyl ethyl ketone, methyl n-propyl ketone, methyl n-butyl ketone, diethyl ketone, methyl isobutyl ketone, methyl n-pentyl ketone, ethyl n-butyl ketone, methyl n-hexyl ketone, diisobutyl ketone, trimethylnonanone, cyclohexanone, methylcyclohexanone, 2,4-pentanedione, acetonylacetone, diacetone alcohol, acetophenone, and fenchone; ether solvents such as ethyl ether, isopropyl ether, n-butyl ether, n-hexyl ether, 2-ethylhexyl ether, ethylene oxide, 1,2-propylene oxide, dioxolane, 4-methyldioxolane, dioxane, dimethyldioxane, ethylene glycol monomethyl ether, ethylene glycol monoethyl ether, ethylene glycol diethyl ether, ethylene glycol mono-n-butyl ether, ethylene glycol mono-n-hexyl ether, ethylene glycol monophenyl ether, ethylene glycol mono-2-ethylbutyl ether, ethylene glycol dibutyl ether, diethylene glycol monomethyl ether, diethylene glycol-monoethyl ether, diethylene glycol diethyl ether, diethylene glycol mono-n-butyl ether, diethylene glycol di-n-butyl ether, diethylene glycol mono-n-hexyl ether, ethoxytriglycol, tetraethylene glycol di-n-butyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, tripropylene glycol monomethyl ether, tetrahydrofuran, and 2-methyltetrahydrofuran; ester solvents such as diethyl carbonate, methyl acetate, ethyl acetate, γ-butyrolactone, γ-valerolactone, n-propyl acetate, isopropyl acetate, n-butyl acetate, isobutyl acetate, sec-butyl acetate, n-pentyl acetate, sec-pentyl acetate, 3-methoxybutyl acetate, methylpentyl acetate, 2-ethylbutyl acetate, 2-ethylhexyl acetate, benzyl acetate, cyclohexyl acetate, methylcyclohexyl acetate, n-nonyl acetate, methyl acetoacetate, ethyl acetoacetate, ethylene glycol monomethyl ether acetate, ethylene glycol monoethyl ether acetate, diethylene glycol monomethyl ether acetate, diethylene glycol monoethyl ether acetate, diethylene glycol mono-n-butyl ether acetate, propylene glycol monomethyl ether acetate, propylene glycol monoethyl ether acetate, propylene glycol monopropyl ether acetate, propylene glycol monobutyl ether acetate, dipropyl glycol monomethyl ether acetate, dipropylene glycol monoethyl ether acetate, glycol diacetate, methoxytriglycol acetate, ethyl propionate, n-butyl propionate, isoamyl propionate, diethyl oxalate, di-n-butyl oxalate, methyl lactate, ethyl lactate, n-butyl lactate, n-amyl lactate, diethyl malonate, dimethyl phthalate, and diethyl phthalate; nitrogen-containing solvents such as N-methylformamide, N,N-dimethylformamide, N,N-diethylformamide, acetamide, N-methylacetamide, N,N-dimethylacetamide, N-methylpropionamide, and N-methylpyrrolidone; and sulfur-containing solvents such as dimethyl sulfide, diethyl sulfide, thiophene, tetrahydrothiophene, dimethyl sulfoxide, sulfolane, and 1,3-propanesultone. These solvents can be used alone or as a mixture of two or more thereof.

It is especially preferred in the invention to use an organic solvent having a boiling point lower than 250° C. Examples thereof include alcohols such as methanol, ethanol, and isopropanol; polyhydric alcohols such as ethylene glycol and glycerol; glycol ether solvents such as ethylene glycol monomethyl ether, ethylene glycol monobutyl ether, diethyl glycol monoethyl ether, diethylene glycol diethyl ether, propylene glycol monopropoyl ether, and dipropylene glycol monoethyl ether; glycol acetate/ether solvents such as ethylene glycol monomethyl ether acetate, diethylene glycol monobutyl ether acetate, ethylene glycol diacetate, and propylene glycol methyl ether acetate; amide solvents such as N,N-dimethylacetamide, N,N-dimethylformamide, and N-methyl-2-pyrrolidone; ketone solvents such as acetone, methyl ethyl ketone, methyl isobutyl ketone, acetylacetone, and methyl amyl ketone; and carboxylic ester solvents such as ethyl lactate, methoxymethyl propionate, and ethoxyethyl propionate. These solvents may be used alone or in combination of two or more thereof.

The amount of the organic solvent to be used in the invention is generally from 0.3 to 25 times (by weight) the amount of the siloxane compound (in terms of the product of complete hydrolysis and condensation).

The coating composition for use in the invention can be produced by mixing the siloxane compound with an organic solvent together with other ingredients according to need.

Other Additives

The coating composition for use in the invention may further contain ingredients such as a colloidal silica, colloidal alumina, and surfactant.

The colloidal silica is a dispersion comprising, for example, any of the aforementioned hydrophilic organic solvents and high-purity silicic acid anhydride dispersed therein. It has an average particle diameter of generally from 5 to 30 nm, preferably from 10to 20 nm, and a solid concentration of generally about from 10 to 40% by weight. Examples of the colloidal silica include the methanol silica sol and isopropanol silica sol manufactured by Nissan Chemical Industries, Ltd., and Oscal, manufactured by Catalysts & Chemicals Industries Co., Ltd.

Examples of the colloidal alumina include Alumina Sol 520, 100, and 200, manufactured by Nissan Chemical Industries, Ltd., and Alumina Clear Sol and Alumina Sol 10 and 132, manufactured by Kawaken Fine Chemicals Co., Ltd.

Examples of the surfactant include nonionic surfactants, anionic surfactants, cationic surfactants, and amphoteric surfactants, and further include silicone surfactants, poly(alkylene oxide) surfactants, and poly(meth)acrylate surfactants.

The coating composition for use in the invention preferably has a total solid concentration of from 2 to 30% by weight. The total solid concentration thereof is suitably regulated according to purposes of the use thereof. When the coating composition has a total solid concentration of from 2 to 30% by weight, the composition not only gives a coating film having an appropriate thickness but has better storage stability.

In the coating composition for use in the invention, the content of alcohols having a boiling point of 100° C. or lower is preferably 20% by weight or lower, more preferably 5% by weight or lower. There are cases where alcohols having a boiling point of 100° C. or lower generate during the hydrolysis and condensation of the compounds (1) and (2). It is therefore preferred to remove such low-boiling alcohols by distillation or another means so as to result in a content thereof of 20% by weight or lower, preferably 5% by weight or lower.

Examples of the substrate to which the coating composition is applied in the invention include silicon wafers, SiO₂ wafers, and SiN wafers. Usable coating techniques include spin coating, dip coating, roll coating, and spraying.

The coating film obtained in the invention by applying the coating composition to a substrate and removing the organic solvent therefrom has a thickness of generally from 0.05 to 3 μm, preferably from 0.1 to 2.5 μm.

In the invention, the coating film thus formed or an organic silica-based film obtained by curing the coating film is irradiated with electron beams.

The irradiation with electron beams according to the invention is conducted at an energy of generally from 0.1 to 50 keV, preferably from 1 to 30 keV, in an irradiation dose of generally from 1 to 1,000 μC/cm², preferably from 10 to 500 μC/cm², more preferably from 10 to 100 μC/cm².

Use of an accelerating voltage of from 0.1 to 50 keV is advantageous in that electron beams can sufficiently penetrate into inner parts of the coating film without passing through the film and damaging the underlying semiconductor device.

Furthermore, when the electron beam irradiation is conducted in an irradiation dose of from 1 to 1,000 μC/cm², the siloxane compound can be reacted throughout the coating film while minimizing damage to the coating film.

The temperature of the substrate during the electron beam irradiation is generally from 25 to 500° C., preferably from 25 to 450° C.

The time required for the coating film to cure with electron beams is generally about from 1 to 5 minutes, which is far shorter than the time of from 15 minutes to 2 hours required for thermal cure. It can therefore be said that electron beam irradiation is suitable for the treatment of individual wafers.

Before being irradiated with electron beams according to the invention, the coating film may be converted to an organic silica film having a dielectric constant of 3.0 or lower, preferably 2.9 or lower, more preferably 2.8 or lower, by heating the substrate at from 250 to 500° C. and thereby heat-curing the siloxane ingredient according to the invention.

The method in which the coating film is heat-cured and then irradiated with electron beams is effective in reducing the unevenness of film thickness attributable to unevenness of electron beam irradiation dose.

The electron beam irradiation in the invention is preferably conducted in an atmosphere having an oxygen concentration of 10,000 ppm or lower, preferably 1,000 ppm or lower.

It is possible to conduct the electron beam irradiation according to the invention in an inert gas atmosphere. Examples of the inert gas include nitrogen, helium, argon, krypton, and xenon. Preferred of these are helium, argon and nitrogen. When the electron beam irradiation is conducted in an inert gas atmosphere, the film being irradiated is less apt to be oxidized, so that a silica-based film retaining a low dielectric constant can be obtained.

The electron beam irradiation may be conducted in an atmosphere having a reduced pressure. The degree of vacuum is generally 133 Pa or lower, preferably from 0.133 to 26.7 Pa.

The silica-based film obtained by the invention has a carbon content (number of carbon atoms) of generally from 5 to 17% by mole, preferably from 9 to 15.5% by mole.

When the silica-based film obtained has a carbon content within that range, it can have improved mechanical strength while retaining a low dielectric constant.

A feature of this silica-based film resides in that it has silicon carbide bonds (Si—C—Si) within the film structure. In an infrared absorption spectrum, the silicon carbide bonds give a characteristic absorption around 890 cm⁻¹.

Because of such features, the silica-based film is excellent in insulating properties, evenness, dielectric constant characteristics, cracking resistance, and hardness.

Consequently, the silica-based film is useful in applications such as dielectric films for semiconductor devices such as LSIs, system LSIs, DRAMs, SDRAMs, RDRAMs, and D-RDRAMs, protective films such as surface coat films for semiconductor devices, dielectric films for multilayered printed circuit boards, and protective or insulating films for liquid-crystal display devices.

The invention will be explained below in more detail by reference to the following Examples.

In the following Examples and Production Example, all “parts” and “percents” are by weight unless otherwise indicated.

### SYNTHESIS EXAMPLE 1

570 g of distilled ethanol, 160 g of ion-exchanged water, and 30 g of 10% aqueous tetramethylammonium hydroxide solution were introduced into a separable flask made of quartz. The contents were stirred and homogenized. A mixture of 136 g of methyltrimethoxysilane and 209 g of tetraethoxysilane was added to this solution. The resulting solution was reacted for 2 hours while being kept at 55° C. 300 g of propylene glycol monopropyl ether was added to this solution. The resulting solution was concentrated with a 50° C. evaporator until the concentration thereof reached 10% (in terms of the content of the product of complete hydrolysis and condensation). 10 g of a 10% acetic acid solution in propylene glycol monopropyl ether was added to the concentrate to obtain a reaction mixture (1).

The product of condensation and other reactions thus obtained had a radius of gyration of 13.4 nm.

### SYNTHESIS EXAMPLE 2

The same procedure as in Synthesis Example 1 was conducted, except that 10% aqueous piperazine solution was used in place of 10% aqueous tetramethylammonium hydroxide solution. Thus, a reaction mixture (2) was obtained.

The product of condensation and other reactions thus obtained had a radius of gyration of 13.0 nm.

### SYNTHESIS EXAMPLE 3

The same procedure as in Synthesis Example 1 was conducted, except that 10% aqueous sodium hydroxide solution was used in place of 10% aqueous tetramethylammonium hydroxide solution. Thus, a reaction mixture (3) was obtained.

The product of condensation and other reactions thus obtained had a radius of gyration of 14.8 nm.

### SYNTHESIS EXAMPLE 4

470.9 g of distilled ethanol, 226.5 g of ion-exchanged water, and 17.2 g of 25% aqueous tetramethylammonium hydroxide solution were introduced into a separable flask made of quartz. The contents were stirred and homogenized. A mixture of 62.86 g of methyltrimethoxysilane and 41.16 g of tetraethoxysilane was added to this solution. The resulting solution was reacted for 2 hours while maintaining at 55° C. 50 g of 20% aqueous nitric acid solution was added to this solution. The resulting mixture was sufficiently stirred and then cooled to room temperature. 400 g of propylene glycol monopropyl ether was added to this solution. The resulting solution was concentrated with a 50° C. evaporator until the concentration thereof reached 10% (in terms of the content of the product of complete hydrolysis and condensation). 10 g of a 10% maleic acid solution in propylene glycol monopropyl ether was added to the concentrate to obtain a reaction mixture (4).

The product of condensation and other reactions thus obtained had a radius of gyration of 20.9 nm.

### SYNTHESIS EXAMPLE 5

470.9 g of distilled ethanol, 226.5 g of ion-exchanged water, and 17.2 g of 25% aqueous tetramethylammonium hydroxide solution were introduced into a separable flask made of quartz. The contents were stirred and homogenized. A mixture of 44.9 g of methyltrimethoxysilane and 68.6 g of tetraethoxysilane was added to this solution over 2 hours. The resulting solution was reacted for 5 hours while maintaining at 59° C. 50 g of 20% aqueous nitric acid solution was added to this solution. The resulting mixture was sufficiently stirred and then cooled to room temperature. 400 g of propylene glycol monopropyl ether was added to this solution. The resulting solution was concentrated with a 50° C. evaporator until the concentration thereof reached 10% (in terms of the content of the product of complete hydrolysis and condensation). 10 g of a 10% maleic acid solution in propylene glycol monopropyl ether was added to the concentrate to obtain a reaction mixture (5).

The product of condensation and other reactions thus obtained had a radius of gyration of 17.9 nm.

### SYNTHESIS EXAMPLE 6

470.9 g of distilled ethanol, 233.3 g of ion-exchanged water, and 10.4 g of 25% aqueous potassium hydroxide solution were introduced into a separable flask made of quartz. The contents were stirred and homogenized. A mixture of 44.9 g of methyltrimethoxysilane and 68.6 g of tetraethoxysilane was added to this solution. The resulting solution was reacted for 2 hours while maintaining at 52° C. 50 g of 20% aqueous nitric acid solution was added to this solution. The resulting mixture was sufficiently stirred and then cooled to room temperature. 400 g of propylene glycol monopropyl ether was added to this solution. The resulting solution was concentrated with a 50° C. evaporator until the concentration thereof reached 10% (in terms of the content of the product of complete hydrolysis and condensation). 10 g of a 10% maleic acid solution in propylene glycol monopropyl ether was added to the concentrate to obtain a reaction mixture (6).

The product of condensation and other reactions thus obtained had a radius of gyration of 24.6 nm.

### EXAMPLE 1

The coating composition 1 obtained in Synthesis Example 1 was applied to an 8-inch silicon wafer by spin coating to obtain a coating film having a thickness of 0.7 μm. This coating film was heated first at 80° C. in the air for 5 minutes and subsequently at 200° C. in nitrogen for 5 minutes and then irradiated with electron beams under the conditions shown in Table 1.

The film obtained was evaluated by the following methods. The results obtained are shown in Table 2.

Dielectric Constant

A sample for dielectric constant measurement was produced by forming an aluminum electrode pattern by vapor deposition on the film obtained. This sample was examined at a frequency of 100 kHz with precision LCR meter HP4284A, manufactured by Yokogawa-Hewlett-Packard, Ltd., by the CV method to determine the dielectric constant of the coating film.

Hardness

A Barkobitch type indenter was attached to a nanohardness meter (trade name: Nanoindentator XP) manufactured by MTS, and this hardness meter was used to determine the universal hardness of the organic silica-based film formed on the silicon wafer. Hardness was measured by Mechanical Properties Microprobe method.

Carbon Content

The number of carbon atoms was determined by the Rutherford backward scattering method and hydrogen forward coil scattering method. The carbon content is shown in terms of the proportion of carbon atoms to all atoms (% by mole).

Examination for Silicon Carbide Bond

Whether or not silicon carbide bonds were present was judged by infrared spectroscopy based on the absorption around 890 cm⁻¹ attributable to the stretching vibration of Si—C—Si.

Cracking Resistance

The composition sample was applied to an 8-inch silicon wafer by spin coating in such an amount as to result in a cured coating film having a thickness of 1.6 μm. This coating film was dried first at 90° C. on a hot plate for 3 minutes and then at 200° C. in a nitrogen atmosphere for 3 minutes. Subsequently, the coated substrate was burned for 60 minutes in a 420° C. vacuum oven evacuated to 6.65 Pa. The coating film obtained was partly incised with a knife and then immersed in pure water for 5 hours. Thereafter, the incision of the coating film was examined with a microscope to evaluate cracking resistance based on the following criteria.

◯: No crack propagation was observed.

X: Crack propagation was observed.

### EXAMPLES 2 TO 6

The coating compositions shown in Table 1 were used in the same manner as in Example 1 to obtain coating films respectively having the thicknesses shown in Table 1. The coating films obtained were heated first at 80° C. in the air for 5 minutes and subsequently at 200° C. in nitrogen for 5 minutes and then irradiated with electron beams under the conditions shown in Table 1.

The films obtained were evaluated in the same manner as in Example 1. The results obtained are shown in Table 2.

### REFERENCE EXAMPLE 1

The coating composition 1 obtained in Synthesis Example 1 was applied to an 8-inch silicon wafer by spin coating to obtain a coating film having a thickness of 0.8 μm. This coating film was heated first at 80° C. in the air for 5 minutes and then at 200° C. in nitrogen for 5 minutes. Subsequently, the coated wafer was inserted into an electron beam irradiator and heated therein at 400° C. for 5 minutes without conducting electron beam irradiation.

The film obtained was evaluated in the same manner as in Example 1. The results obtained are shown in Table 2.

The time required for electron beam irradiation in each of Examples 1 to 6 was within 7 minutes.

TABLE 1

| | | | Conditions for electron beam irradiation | | | | |
|---|---|---|---|---|---|---|---|
| | | Film | Accelerating | Irradiation | Ambient | Ambient | |
| | Coating | thickness | voltage | dose | temperature | pressure | Ambient |
| Example | composition | (μm) | (keV) | (μC/cm²) | (° C.) | (Pa) | gas |
| Example 1 | 1 | 0.35 | 2.0 | 30 | 350 | 1.33 | N₂ |
| Example 2 | 2 | 0.9 | 7.5 | 700 | 400 | 1.33 | He |
| Example 3 | 3 | 0.1 | 1.5 | 75 | 300 | 13.3 | He |
| Example 4 | 4 | 0.35 | 3.0 | 150 | 350 | 1.33 | He |
| Example 5 | 5 | 0.4 | 4.0 | 100 | 350 | 9310 | He |
| Example 6 | 6 | 0.45 | 4.5 | 200 | 400 | 1.33 | Ar |

| | | | | | | |
|---|---|---|---|---|---|---|
| Reference | 1 | 0.7 | No electron beam | 400 | 6.65 | N₂ |
| Example 1 | | | Irradiation | | | |

TABLE 2

| | | | Carbon | |
|---|---|---|---|---|
| | Dielectric | Hardness | content | Silicon |
| | constant | (GPa) | (mol %) | carbide |
| Example 1 | 2.2 | 0.6 | 10.5 | Present |
| Example 2 | 2.5 | 0.9 | 10.5 | Present |
| Example 3 | 2.1 | 0.6 | 10.5 | Present |
| Example 4 | 2.0 | 0.5 | 10.5 | Present |
| Example 5 | 2.2 | 0.7 | 12.6 | Present |
| Example 6 | 1.9 | 0.5 | 12.6 | Present |
| Reference | 3.11 | 0.3 | 10.8 | Absent |
| Example 1 | | | | |

According to the invention, a film having a low dielectric constant and excellent mechanical strength can be provided.

What is claimed is:

1. A process for producing a silica-based film comprising a step of irradiating a film comprising at least one siloxane compound having a radius of gyration of from 5 to 50 nm with electron beams to thereby convert the film into a film having a dielectric constant of 3 or lower.

2. The process as claimed in claim 1, wherein the silica-based film has a dielectric constant of 2.8 or lower.

3. The process as claimed in claim 1, wherein the silica-based film has silicon carbide bonds represented by Si—C—Si.

4. The process as claimed in claim 1, wherein the siloxane compound is a product of the hydrolysis and/or condensation of at least one compound selected from the group consisting of compounds represented by the following formula (1) and compounds represented by the following formula (2) in the presence of an alkali catalyst:
R¹ₐSi(OR²)₄₋ₐ (1)
wherein R¹ represents a monovalent organic group or a hydrogen atom; R² represents a monovalent organic group; and a is an integer of 0 to 2,
R³_{b}(R⁴O)_{3-b}Si—(R⁷)_{d}—Si(OR⁵)_{3-c}R⁶_{c} (2)
wherein R³, R⁴, R⁵, and R⁶ may be the same or different and each represents a monovalent organic group; b and c may be the same or different and each is an integer of 0 to 2; R⁷ represents an oxygen atom or a group represented by —(CH₂)ₙ—, wherein n is 1 to 6; and d is 0 or 1.

5. The process as claimed in claim 1, wherein the film comprising a siloxane compound has a thickness of from 0.05 to 3 μm.

6. The process as claimed in claim 1, wherein the electron beam irradiation is conducted at an energy of from 0.1 to 50 keV.

7. The process as claimed in claim 1, wherein the electron beam irradiation is conducted at an irradiation dose of from 1 to 1,000 μC/cm².

8. The process as claimed in claim 1, wherein the electron beam irradiation is conducted at 25 to 500° C.

9. The process as claimed in claim 1, wherein the electron beam irradiation is conducted in an atmosphere having an oxygen concentration of 10,000 ppm or lower.

10. The process as claimed in claim 1, wherein the electron beam irradiation is conducted in an inert gas atmosphere.

11. The process as claimed in claim 1, wherein the electron beam irradiation is conducted at 133.3 Pa or lower.

12. The process as claimed in claim 1, wherein the film comprising a siloxane compound is heat-cured at 300 to 500° C. before being subjected to the electron beam irradiation.

13. A process for producing a silica-based film comprising a step of irradiating a film comprising a product of the hydrolysis and/or condensation of tetraalkoxysilane and alkyltrialkoxysilane with electron beams to thereby convert the film into a film having a dielectric constant of 3 or lower.

14. A silica-based film obtained by the process as claimed in claim 1.

15. The silica-based film as claimed in claim 14, which has a carbon content of from 5 to 17% by mole.

16. A low-dielectric film comprising the silica-based film as claimed in claim 14.

17. A semiconductor device having the low-dielectric film as claimed in claim 16.
